(19) United States
(12) Patent Application Publication
(10) Pub. No.: US 2016/0129613 A1
(43) Pub. Date: May 12, 2016

(54) METHOD AND DEVICE FOR PRESSING A SEALING COMPOUND ON THE INSIDE OF A LID FOR CONTAINERS

(71) Applicant: SAETA GMBH & CO.KG, Wedel (DE)

(72) Inventor: Helmuth Neben, Hamburg (DE)

(73) Assignee: SAETA GMBH & CO. KG, Wedel (DE)

(21) Appl. No.: 14/891,113

(22) PCT Filed: May 12, 2014
(86) PCT No.: PCT/EP2014/059630

§ 371 Date: Nov. 13, 2015

(30) Foreign Application Priority Data
May 13, 2013 (DE) 10 2013 008 045.2

(51) Int. Cl. B29C 43/18; B29C 43/52; B29C 43/02; B65D 53/06

(52) U.S. Cl. CPC B29C 43/18; B65D 53/06; B29C 43/52; B29C 43/021; B29C 2043/189; B29C 2043/3205

(57) ABSTRACT

A method for pressing a sealing compound onto the inside of a lid for containers is described. An annular structure consisting of plasticized sealing compound is located on the lid base and is pressed flat by means of an annular press punch onto the lid base and onto the lid wall adjacent to the lid base. The annular press punch is pressed between an inner molded part arranged radially to the inside of the press punch, and an annular outer molded part arranged radially to the outside of the press punch and forming an annular gap to the lid base, and is pressed toward the lid base onto the annular structure. The plasticized sealing compound is pressed into the gap and radially to the outside through the gap onto the lid base and onto the lid wall adjacent to the lid base. A corresponding device is also described.

### TECHNICAL FIELD

The invention relates to a method for pressing a sealing compound onto the inside of a lid for containers. In addition, the invention relates to a device for pressing a sealing compound onto the inside of a lid for containers.

### BACKGROUND

Containers can be food containers such as baby food containers or the like. Lids are known under the brand name of Twist-Off (TO) with lobes in the area of the inside of the cover wall. The lobes interact with a corresponding container thread. With such lids, the sealing compound is applied flat adjacent to the lid wall basically only onto the lid base. A method and a device for applying and pressing the sealing compound onto such lids is, for example, known from DE 10 2009 040 802 A1.

In addition, lids without lobes are known under the brand name of Press On Twist-Off (PT). With such lids, the sealing compound must be additionally applied extensively to the area of the lid base adjacent to the lid wall, and to the inside of the lid wall. In this area, a thread forms in the sealing compound when pressing the lid onto a container. In order to distribute the sealing compound onto the lid wall as well, the employed press punch must displace the annular structure of plasticized sealing compound deposited on the lid base such that the sealing compound is also pressed up onto the wall.

### SUMMARY

One problem in the process of sealing with PT lids is air inclusions in a critical area, i.e., an area in which the seal may not have any elasticity arising from an air inclusion. This applies in particular to the transition between the lid base and lid wall.

An object of the invention is to provide a method and a device for pressing a sealing compound onto the inside of a lid for containers by means of which air inclusions are reliably avoided when applying the sealing compound onto the lid base and onto the lid wall. Generally, an annular structure consisting of plasticized sealing compound is located on the lid base and is pressed flat by means of an annular press punch onto the lid base and onto the lid wall adjacent to the lid base.

Embodiments of the invention achieve the object on the one hand by a method for pressing a sealing compound onto the inside of a lid for containers, wherein an annular structure consisting of plasticized sealing compound is located on the lid base and is pressed flat by means of an annular press punch onto the lid base and onto the lid wall adjacent to the lid base, wherein the annular press punch is pressed between an inner molded part arranged radially to the inside of the press punch, and an annular outer molded part arranged radially to the outside of the press punch and forming an annular gap from the lid base, and is pressed toward the lid base onto the annular structure consisting of plasticized sealing compound, wherein the plasticized sealing compound is pressed into the gap and radially to the outside through the annular gap onto the lid base and onto the lid wall adjacent to the lid base.

In addition, the embodiments of the invention achieve the object by a device for pressing a sealing compound onto the inside of a lid for containers comprising an annular press punch, an inner molded part arranged radially to the inside of the press punch, and an annular outer molded part arranged radially to the outside of the press punch and forming an annular gap to the lid base, wherein the press punch can be pressed toward the lid base between the inner molded part and the annular outer molded part onto an annular structure consisting of plasticized sealing compound located on the lid base so that the plasticized sealing compound is pressed into the gap and radially to the outside through the annular gap onto the lid base and onto the lid wall adjacent to the lid base.

The lid to be provided with the sealing compound possesses a lid base and a lid wall. The lid base can for example be circular. The lid wall runs in the shape of a ring, in particular in the shape of a circular ring, around the lid base. The lid wall can extend perpendicular relative to the lid base or at a different angle, or curved as well. At its end bordering the opening of the lid, the lid wall can have an annular thickening, in particular a curl. All of this is known and will therefore not be further explained. The cover can for example be provided for food containers, in particular for baby food containers or the like. It can be a lid without lobes known under the trade name of Press On Twist-Off (PT). Of course it can also be a lobed lid, or a lid with a thread where sealing compound is to be applied onto the wall of the lid.

An inner molded part and an annular outer molded part are provided between which the annular press punch is movably guided in an axial direction. An annular peripheral gap exists at least between the end of the annular outer molded part facing the lid base, and the lid base. The press punch is moved in an axial direction within the annular space between the inner and outer molded part. The space formed between the inner and outer molded part can in particular be configured such that there is basically no distance between the walls of the press punch and the inner or respectively outer molded part. This reliably prevents sealing compound from entering into the area between the press punch and inner or respectively outer molded part during pressing.

An annular structure is located on the lid base that was placed on the lid base in a preceding applicator station and is in a plasticized state. The annular structure can be a closed ring consisting of plasticized material, in particular an O-ring. The annular structure can, however, also be a non-closed structure, i.e., a ring shape with one or more interruptions, which structure is then pressed into a closed ring contour. In particular, a plurality of sections consisting of plasticized sealing compound can be placed along an annular shape on the lid base before the pressing, although at a distance from each other in the peripheral direction of the ring shape. Starting from the lid base, the annular structure consisting of sealing compound extends higher than the height of the annular gap between the lid base and the outer molded part. To the extent that the annular structure possesses a circular cross-section, the diameter of the annular structure is greater than the distance between the lid base and outer molded part. Before pressing, the annular structure consisting of plasticized sealing compound is located between the end of the press punch facing the lid base, and the lid base. By means of the press punch moved in an axial direction toward the lid base, the plasticized sealing compound is pressed into the gap between the lid base and the outer molded part, and partially through the gap radially to the outside. In the process, the sealing compound is deformed flat. After pressing, a flat layer consisting of sealing compound is, on the one hand, in the gap between the lid base and outer molded part, as well as radially to the outside of the annular gap on the lid base and, on the other hand, on the adjacent inner surface of the lid wall to which it adheres.

The inner molded part can extend to the lid base and thereby form a closed limit to the inside. In this case, no sealing compound enters the area of the lid base covered by the inner molded part. It is also possible, however, for the inner molded part to also form a gap to the lid base. In this case, the sealing compound also enters the area of the lid base during pressing, above which the inner molded part is located. It is then in particular possible for the entire surface of the lid base, or at least part of the surface of the lid base, to be covered with sealing compound after pressing. The inner molded part can be movable by suitable drive means in an axial direction as well, so that the explained alternative methods can be changed depending on the application.

The applicator, which can form a spatially separate component of the device, can be designed in principle as is known from DE 10 2009 040 802 A1. By means of this design, particularly easy placement of the annular structure on the lid-base is achieved while reliably avoiding adhesions on the applicator. The respective speed required for reducing the gap and pressing out the sealing compound can be empirically determined by a person skilled in the art. Among other things, the speed depends on the dimensions of the applicator and the annular structure to be formed.

In the applicator, the annular structure consisting of sealing compound can be deposited on the lid base further radially to the inside than is the case in the prior art. A chamber is formed that is delimited by the press punch, the lid base, as well as the inner and outer molded part with a narrow outlet to the outside formed by the gap between the outer molded part and the lid base. The sealing compound is located in this chamber before pressing. Then, using the press punch, the sealing compound is pressed through the gap out of the chamber radially to the outside and against the lid wall. Starting from the lid base, the sealing compound is moved in the process toward the lid opening. The distribution of the sealing compound is consequently reversed in comparison to the prior art, i.e., not by pressure from above toward the lid base with corresponding deformation of the sealing compound, but rather by flowing into a space formed between the outer molded part and the lid wall with a direction of flow toward the lid opening. This reliably prevents air inclusions that can arise in the prior art.

Furthermore, the method according to the description causes additional shear of the plasticized sealing compound. This reduces the viscosity of the sealing compound and additionally assists in the thin coating of the inside of the lid wall. This additional shear improves the ease of applying the sealing compound relative to the strong shear within the applicator that already arises when applying the annular structure onto the lid base.

When the press punch is moved completely onto the lid base, only a minimum amount of sealing compound remains between the press punch and lid base. Of course, a greater amount of sealing compound can remain between the press punch and the lid base as well, in particular when the press punch is not moved completely toward the lid base. After pressing, the press punch and inner and outer molded parts are removed.

As already mentioned, the plasticized sealing compound can be pressed through the annular gap onto the lid wall, in particular into a space formed between the annular outer molded part and the lid wall, starting from the lid base toward the opening in the lid. Air inclusions are thereby prevented in a particularly reliable manner. Furthermore, a gap with a width less than 0.1 mm, preferably less than 0.05 mm, can exist between the annular outer molded part and the end of the lid wall facing away from the lid base. A gap with a width of 0.01 mm to 0.03 mm has proven to be particularly suitable in this regard. In this advantageous embodiment, the space, apart from the gap in the area of the lid opening, forms a basically closed chamber. The small gap ensures that the air displaced when the plasticized sealing compound flows into the space can escape to the outside. At the same time, the gap is sufficiently small to prevent the plasticized sealing compound from flowing through the gap, in particular due to its comparatively high viscosity. Instead with this design of the space as a chamber that is closed except for the gap, the sealing compound pressed as described herein is exposed to significant pressure that further improves the adhesion of the sealing compound in particular on the lid wall. It is important for the volume of plasticized sealing compound applied to the lid base and then to be pressed to correspond as precisely as possible to a previously determined setpoint. Otherwise, the pressure arising while pressing may be undesirably high or undesirably low. The plasticized sealing compound therefore must be precisely dosed.

According to another design, an annular area of the lid base bordering the lid wall can be recessed in comparison to an area of the lid base radially to the inside. Frequently, such lids have an annular recessed area radially to the outside. The annular structure consisting of sealing compound in the applicator can then be at least partially deposited in the area of the recess in the lid base. The outer molded part is then arranged in the area of the annular recess of the lid base.

According to another design, the plasticized sealing compound can substantially cover the entire inside of the lid wall after being pressed with the annular press punch. If the lid is a lobe-free lid, in particular a lid known by the brand name of Press On Twist-Off (PT), such a design is advantageous since the thread is formed in the sealing compound itself with such lids. Since the entire lid wall is covered, a particularly large area for thread formation and sealing is available.

According to another design, the press punch and/or the inner molded part and/or the outer molded part, can be cooled to a temperature such that adhesion of the plasticized sealing compound is prevented. The sealing compound is heated to a sufficient temperature to be flowable. The lid can also be heated to a set temperature in order to improve the adhesion of the melt consisting of sealing compound. After being applied onto the lid base and lid wall, the sealing compound cools, and possibly the lid and the sealing compound adhere to the surface of the lid. By suitably cooling the components coming into contact with the sealing compound according to the invention, undesirable adhesions of sealing compound to these components are reliably prevented.

An exemplary embodiment of the invention is explained in greater detail below with reference to figures.

### BRIEF DESCRIPTION OF THE DRAWINGS

FIG. 1 shows a sectional view of a section of a device according to an embodiment of the invention in a first operating state, and

FIG. 2 shows the section of the device from FIG. 1 in a second operating state.

If not specified otherwise, the same reference numbers are used for the same objects in the figures.

### DETAILED DESCRIPTION

The figures show a lid for a container such as a food container like a baby food container or the like. The lid possesses an, e.g., circular lid base 10 and an annular lid wall 12 surrounding the lid base 10, e.g., in the shape of a circular ring. At its end bordering the opening of the lid, the lid wall 12 has a curl 14, e.g., in the shape of a circular ring. Above that, the lid base 10 has an annular area 16 that borders the lid wall 12 and is recessed in comparison to the remaining lid base. The lid 10 is in particular a lid without lobes known under the brand name of Press On Twist-Off (PT).

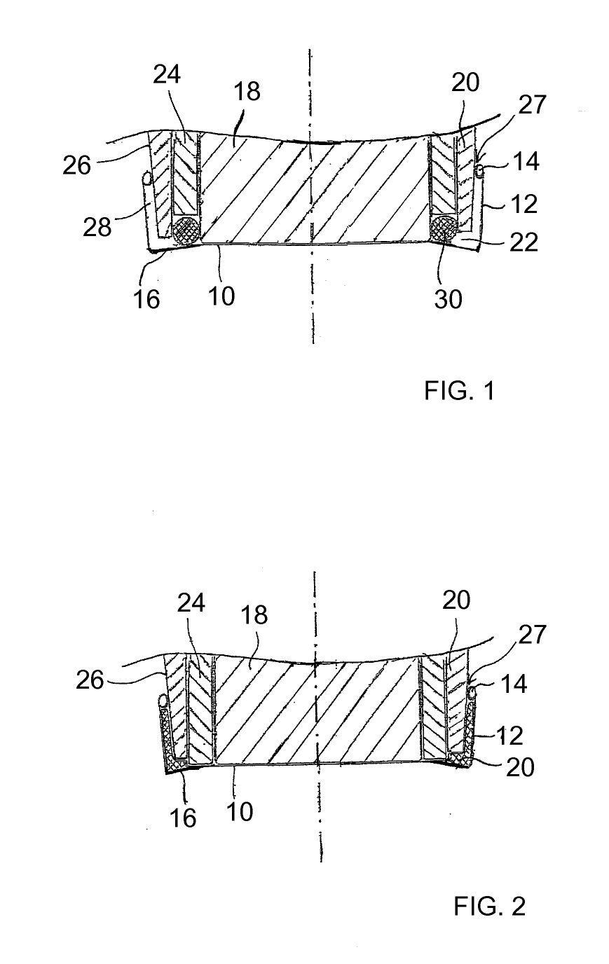

Also discernible in the figures is an inner molded part 18 extending up to the lid base 10 in the depicted example. It is also possible, however, for the inner molded part 18 to not extend up to the lid base 10, i.e., a gap is formed between the inner molded part 18 and the lid base 10. It is also possible for the inner molded part 18 to be movable in an axial direction in a suitable manner so that a gap can optionally be formed between the inner molded part 18 and lid base 10, or not. Furthermore, an outer molded part 20 surrounding the inner molded part 18 in the shape of a ring is discernible. An annular gap 22 is formed between the end of the annular outer molded part 20 facing the lid base 10, and the lid base 10, especially the recessed area 16 in the present case. Furthermore, it can be seen in the figures that a space is formed between the outer wall of the inner molded part 18 and the inner wall of the annular outer molded part 20 in which an annular press punch 24 is movably guided in an axial direction. In particular, the press punch 24 can be moved with a drive (not shown) out of the position shown in FIG. 1 in an axial direction toward the lid base 10 as will be further explained below.

In the figures, it can also be seen that there is basically no distance between the inner wall of the annular press punch 24 and the outer wall of the inner molded part 18, and between the outer wall of the press punch 24 and the inner wall of the outer molded part 20. Furthermore, it can be seen that the outer wall 26 of the annular outer molded part 20 runs more or less parallel to the lid wall 12 and, except for a narrow additional gap 27, extends up to the annular curl 14 of the lid wall. In this manner, an annular space 28 connected to the gap 22 between the lid base 10 and the outer molded part 20 is formed between the outer wall 26 of the outer molded part 20 and the inside of the lid wall 12. The space 28 forms a closed chamber except for the gap 27 formed in the area of the lid opening between the outer molded part 20 and the inside of the lid wall 12. The gap 27 between the outer molded part 20 and the inside of the lid wall 12 possesses a small width of for example less than 0.05 mm, in particular within a range of 0.01 mm to 0.03 mm. Of course, the gap 27 can also be formed between a correspondingly thick area in the outer molded part 20 and the inside of the lid wall 12, for example when the inside of the lid wall 12 possesses no curl, or an insufficient curl. It is also conceivable to provide an additional annular part that is arranged concentric to the outer molded part 20 to form the gap 27 and that for example is arranged movable in an axial direction on the outside of the outer molded part 20.

FIG. 1 also shows an annular structure consisting of plasticized sealing compound 30 that was placed on the lid base 10 by means of an applicator (not shown) in a spatially separate applicator station (also not shown). As mentioned above, the annular structure can be a closed ring consisting of plasticized sealing compound. It is also possible, however, for the annular structure to be a non-closed ring consisting of plasticized sealing compound where individual sections consisting of plasticized sealing compound have been placed along a ring shape, but at a distance from each other. In the depicted example, the annular structure consisting of plasticized sealing compound 30 was placed on the lid base 10 in the recessed area 16 of the lid base. In this case, the annular structure consisting of plasticized sealing compound 30 is located directly below the annular press punch 24 and between the inner molded part 18 and the annular outer molded part 20. As can be seen in the starting position in FIG. 1, an additional chamber is formed which is delimited by the press punch 24, the lid base 10 and the inner and outer molded part 18, 20. The chamber possesses a narrow outlet to the outside formed by the gap 22 between the outer molded part 20 and the lid base 10. The annular structure consisting of plasticized sealing compound 30 is located in this chamber in the starting position in FIG. 1 before pressing.

To press, the press punch 24 is moved in an axial direction toward the lid base 10, i.e., from top to bottom in FIG. 1. This presses the plasticized sealing compound 30 out of the chamber to the outside into the gap 22 between the outer molded part 20 and the lid base 10, and through this gap 22 into the space 28 that also forms a chamber as can be seen in FIG. 2. In the process, the plasticized sealing compound 30, starting from the lid base 10, in particular the recessed area 16, is pressed toward the lid opening, i.e., upward in FIG. 2, into the space 28 and onto the lid wall 12. The displaced air can escape through the narrow gap between the outer molded part 20 and the inside of the lid wall 12. However, sealing compound cannot pass through this gap. The sealing compound 30 is therefore exposed to significant pressure during pressing that promotes adhesion of the sealing compound 30 on the lid wall 12. As the sealing compound 30 flows into the space 28 from below, air inclusions are reliably avoided between the sealing compound 30 and the lid wall 12, or respectively the lid base 10, in particular at the transition between the recessed area 16 and the lid wall 12. Instead, a coating of the recessed area 16 of the lid base 10 and basically the entire inner surface of the lid wall 12 is achieved.

Furthermore, with the design described herein, additional shear of the plasticized sealing compound 30 arises, which reduces the viscosity of the sealing compound 30 and further improves the thin coating, in particular of the lid wall 12.

1. A method for pressing sealing a compound onto the inside of a lid for containers, the lid comprising a lid base and a lid wall, the method comprising:
locating an annular structure consisting of plasticized sealing compound on the lid base; and
pressing the annular structure flat by means of an annular press punch onto the lid base and onto the lid wall adjacent to the lid base, wherein:
the annular press punch is pressed between an inner molded part arranged radially to an inside of the annular press punch, and an annular outer molded part arranged radially to an outside of the annular press punch and forming an annular gap to the lid base, and
the annular press punch is pressed toward the lid base onto the annular structure, wherein the plasticized sealing compound is pressed into the annular gap and radially to the outside through the annular gap onto the lid base and onto the lid wall adjacent to the lid base.

2. The method according to claim 1, wherein the inner molded part extends to the lid base.

3. The method according to claim 1, wherein the inner molded part forms a gap to the lid base such that the lid base is coated with the plasticized sealing compound.

4. The method according to claim 1, wherein the plasticized sealing compound is pressed onto the lid wall through the annular gap into an annular space formed between the annular outer molded part and the lid wall toward an opening in the lid.

5. The method according to claim 4, wherein a gap with a width less than 0.1 mm exists between the annular outer molded part and an end of the lid wall facing away from the lid base.

6. The method according to claim 1, wherein an annular area of the lid base adjacent to the lid wall is recessed in comparison to an area of the lid base radially to the inside.

7. The method according to claim 1, wherein the plasticized sealing compound substantially covers an entire inside of the lid wall after pressing with the annular press punch.

8. The method according to claim 1, wherein the lid is a lobe-free lid.

9. The method according to claim 1, wherein at least one of the press punch, the inner molded part, or the outer molded part is cooled to a temperature such that adhesion of the plasticized sealing compound is prevented.

10. A device for pressing a sealing compound onto the inside of a lid for containers, the lid including a lid base and a lid wall, the device comprising:
an annular press punch;
an inner molded part arranged radially to an inside of the annular press punch; and
an annular outer molded part arranged radially to an outside of the press punch and forming an annular gap to the lid base,
wherein the annular press punch presses toward the lid base between the inner molded part and the annular outer molded part onto an annular structure consisting of plasticized sealing compound located on the lid base so that the plasticized sealing compound is pressed into the annular gap and radially to the outside through the annular gap onto the lid base and onto the lid wall adjacent to the lid base.

11. The device according to claim 10, wherein the inner molded part extends to the lid base.

12. The device according to claim 10, wherein the inner molded part also forms a gap to the lid base.

13. The device according to claim 10, wherein an annular space is formed between the annular outer molded part and the lid wall through which the plasticized sealing compound is pressed onto the lid wall through the annular gap toward an opening of the lid.

14. The device according to claim 13, wherein a gap with a width less than 0.05 mm exists between the annular outer molded part and an end of the lid wall facing away from the lid base.

15. The device according to claim 10, wherein an annular area of the lid base adjacent to the lid wall is recessed in comparison to an area of the lid base radially to the inside.

16. The device according to claim 10, wherein the device is designed to substantially cover an entire inside of the lid wall with the plasticized sealing compound.

17. The device according to claim 10, wherein the lid is a lobe-free lid.

18. The device according to claim 10, wherein at least one of the press punch, the inner molded part, or the outer molded part is cooled to a temperature such that adhesion of the plasticized sealing compound is prevented.
